(19) United States
(12) Patent Application Publication
(10) Pub. No.: US 2015/0209829 A1
(43) Pub. Date: Jul. 30, 2015

(54) EXTRACTION PROCESS OF CLAY, SILICA AND IRON ORE BY DRY CONCENTRATION

(71) Applicant: GREEN METALS SOLUÇÕES AMBIENTAIS S.A., Belo Horizonte (BR)

(72) Inventors: Dener DE SIQUEIRA, Belo Horizonte (BR); Ricardo André FIORROTTI PEIXOTO, Ouro Preto (MG); JOÃO BOSCO DE BARROS, Belo Horizonte (BR)

(21) Appl. No.: 14/532,715

(22) Filed: Nov. 4, 2014

(30) Foreign Application Priority Data
Jan. 28, 2014 (BR) 10 2014 002076-4

(51) Int. Cl. B07B 9/00; B02C 23/08; B07B 11/02

(52) U.S. Cl. CPC B07B 9/00; B07B 11/02; B02C 23/08

(57) ABSTRACT

This disclosure relates to a water-less extraction process to collect clay, silica and iron ore from tailings taken from tailings dams and deposits by drying, dry sifting, density separation, mechanical friction separation, air classification separation, milling and magnetic separation. This is achieved by using pieces of equipment arranged in sequential order, as follows: a horizontal rotary sieve (4) with a classifier equipped with up to five outlets for the discharge of particles of several different sizes; a horizontal concentrator (5) equipped with blades (5.3) and fins (5.2) for the removal of clay, that is connected to an exhaust system (3); a vertical air concentrator (5) for dry separation of clay by centrifugal force, linked to a second exhaust system (7) in addition to a magnetic separator (8) that improves the performance when extracting materials.

### PRIORITY CLAIM AND CROSS-REFERENCE TO RELATED APPLICATIONS

This application claims priority under 35 U.S.C. 119 to Brazilian Patent Application No. 10 2014 002076-4 filed on 28 Jan. 2014, the entire disclosure of which is incorporated by reference herein.

The present disclosure relates to a process to extract clay, silica and iron ore contained in tailings resulting from the beneficiation process and taken from dams and deposits. This is achieved by drying, dry sieving, density separation, mechanical friction separation, separation by air classifier, milling and magnetic separation, without using any water, that is to say, by a fully dry process. The process uses innovative equipment through its several stages, more specifically a horizontal rotary sieving machine with a classifier equipped with up to five outlets for the different particle sizes, a horizontal concentrator equipped with blades and fins to remove clay connected to an exhaust system, a vertical air concentrator for dry separation of clay by centrifuge force, the centrifugal force that is connected to the exhaust system, in addition to a magnetic separator that improves the performance of extraction.

The process makes it possible to exploit mine tailings more productively and with less damage to the environment. Actually, it helps the environment to recover since it does not use water, including waste contained in tailings dams, by using innovative equipment in an efficient way throughout the various stages. The purpose of using mine tailings produced by the mining industry as a result of the beneficiation of tailings dams and deposits that is enabled by the process described herein, is to extract clay, silica and ore from the tailings, and separate them from one another. The processed material will yield a percentage of clay of approximately 5 to 8%, a percentage of silica of approximately 30 to 45%, with a recovery rate of 98% (ninety-eight percent), and ore will yield from 35 to 50%, with a 98% recovery (ninety-eight percent).

With their ore extraction operations, mining companies tend to generate a great deal of waste rocks and tailings that are normally dumped in decanting tanks or tailings dams. The tailings dams absorb a great amount of financial and operating resources for their maintenance and heightening, and are subject to leaks and spills that may release large amounts of waste into the environment, thereby creating imminent risk, as well as immeasurable impacts on the environment. Moreover, the tailings dams disfigure the landscape and are a source of concern to the public authorities, health agencies and the population around them.

The average domestic production of ore is greater than 400,000,000 (four hundred million) tons/year, and the annual amount of waste is of the order of 40,000,000 (forty million) tons. The waste coming from the extraction and beneficiation of ore has a fine grain size, with 100% of the material smaller than 9.5 mm. Mining waste is comprised essentially of water, clay, SiO₂ and ore. On average, this mining waste is comprised 50% of water and the remaining 50% is solid material. This results in the generation of more than 20,000,000 tons/year of clay, silica and ore that can be used in industrial processes as long as adequate separation is carried out.

The clay could be used in the ceramic industry or as raw material for civil or highway engineering, silica could be used in the glass industry or as raw material for civil or highway engineering, and ore could be used in the steel industry. These products may then be used industrially since these materials have a chemical composition that is very close to that of the clay, silica and ore used commercially, and also present an alternative to the exploitation processes, as well as a means to reduce environmental risks since they contain no contaminants.

Density separation is widely used in ore separation and concentration processes. Magnetic separation is a well-known method in ore processing and is used to concentrate and/or purify several minerals. It can be used in accordance with the different responses to the magnetic field presented by individual mineral species. Depending on their magnetic susceptibility, in other words the property of a material that determines its response to a magnetic field, minerals and materials fall into two categories: those that are attracted to the magnetic field and those that are repelled by it. The first category includes magnetic minerals, those that are strongly attracted to the magnetic field, and paramagnetic minerals, which are weakly attracted. Diamagnetic materials are those that are repelled by the magnetic field. Magnetic separation can be performed by a dry or a wet process. The dry method is generally used for coarse grains and the method employing starch for finer grains.

The present disclosure introduces a processing which the grain size of the material to be used is 100% smaller than 1 mm (one millimeter), and ore is the main magnetic element found in the tailings, in other words, its high magnetic intensity is needed to attract it, varying from 1.5000 to 21.000 G (gauss), in addition to the use of a drum and a magnetic roll to achieve separation of silica and ore.

With regard to the existing equipment and processes for ore separation in the current state of the technique, the process shown here provides a productivity gain of over 30% (thirty percent) in material classification due to the use of the innovative sifting unit, as well as in clay separation as a result of the use of the sieve and horizontal concentrator. These make it possible to directly send the ores already in an advanced stage of extraction to the vertical air concentrator. It is substantially different from following documents that were used until now:
PI05955452-A provides only a process for the production of silica that does not take into account the recovery of ore and alumina and other elements comprised in clay, a raw material of great interest to the ceramic beneficiation industry since this recovered fraction of material may contribute in a significant way to the reduction of consumption of clay minerals from the mines, a fact that is taken into consideration in this process;
PI0803327-7A2 shows a process of ore concentration based on the reduction of water consumption as well on the sending of tailings to an industrial plant for drainage and disposal, making it different from the process shown here because as all the constituent elements of the mining waste will be used in engineering processes as raw materials in an environmentally safe and sustainable way causing no impact on the environment;
PI096025301-A presents a means to recover ores from red mud by hydrometallurgical treatment, however, even though it is related to the matter at hand, it does not compete with processes and methods developed and presented in this patent;
patent BR 10 2012 00875 deals with the separation of the iron ore contained in tailings, but uses several processes with added water, while the present disclosure uses, in addition to density and magnetic separation, previous drying and grinding, all stages being dry, without no water added;
patent BR 10 2012 008340-0 uses a natural gas drier with mechanic agitation, used on ore particles with diameters varying from 2 to 0.15 mm, being different from this proposal that uses a rotary LPG-fired drier with a countercurrent temperature system used on particles of up to 50 mm in diameter, which prevents clays form bonding with ore particles; another differential is that in this proposal, the sieving is dry, while in the patent previously filed sieving is performed in naturally damp conditions before feeding the dryer;
patent BR 10 2012 020819-9, even though it refers to a dry separation process, does not have the main components supplied by this disclosure, namely the horizontal sieving unit, the horizontal concentrator equipped with blades and fins for clay removal, nor the vertical air concentrator, all of which introduce operational technical benefits by skipping several steps of the process, thereby saving time, energy and equipment wear and tear, in addition to extracting a larger amount of clay and obtaining higher quality silica and ore. In addition to the differences mentioned above, the following benefits with regard to the state of the technique can be pointed out:
it is an industrial water-less process for the use of materials that are treated as waste, turning them into raw materials for industrial production in a cost-effective and productive way;
it uses a horizontal concentrator for clay removal, in addition to blades and fins with an exhaustion system, which improves the performance of magnetic separation;
it uses a vertical air concentrator;
it uses a horizontal sieve which, unlike the vibratory sieves, makes it possible to remove clay by shaking the material inside the pipe formed by the variously graded screens;
the previous patents do not include magnetic drums and rollers but only rollers; those are also different since they only work at up to 16,000 G against the 21.000 G (gauss) in this disclosure;
it skips several steps of the processes known until now thereby saving time, energy and equipment wear and tear; it increases productivity in the ore recovery process by extracting a larger amount of clay, besides obtaining silica and ore of higher quality.

For a better understanding of the process, the following drawings are shown:

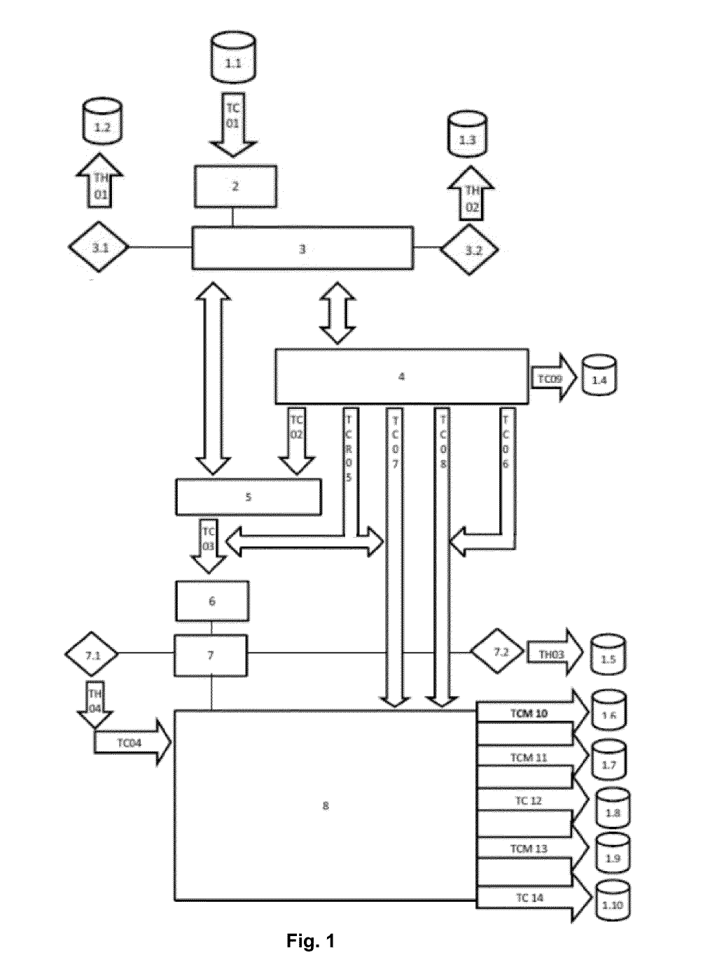

FIG. 1 represents the flowchart of the whole operational process following a continuous production line, from the coming out of the tailings from where they were stored to the final storage point for the separated materials.

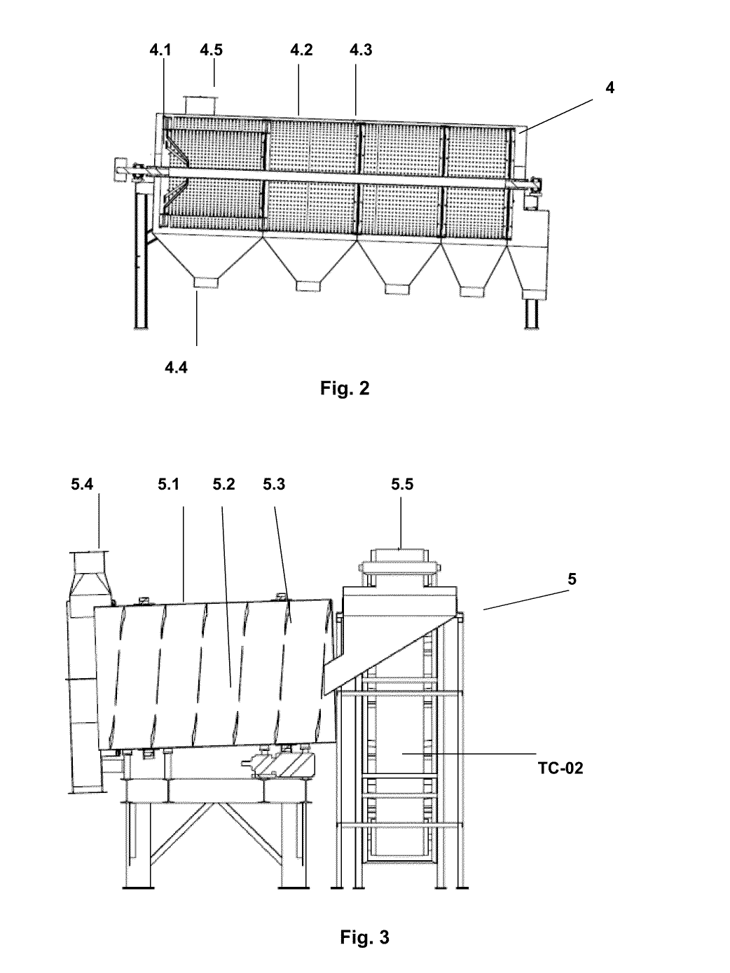

FIG. 2 shows the horizontal sieving unit.

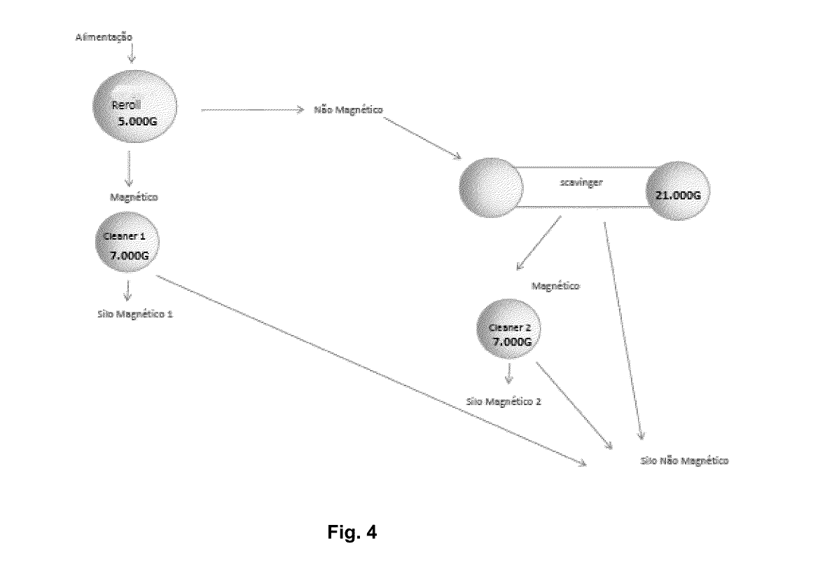

FIG. 3 shows the horizontal concentrator.

FIG. 4 shows the flowchart of the magnetic separation operation.

The Process of extracting clay, silica and ore by dry concentration using tailings left from the beneficiation process of tailings dams and deposits by means of drying, sifting, density separation, grinding and magnetic separation offers a simple, cost-effective and practical alternative that is comprised of two main stages, both water-less:
the first stage, subdivided in four phases, removes clay minerals rationally in order to enable the use of dry magnetic concentrators, which come into play in the drying, sifting, horizontal concentration and vertical air separation phases;
the second stage results in the separation of silica from ore by a dry magnetic separator, preferentially equipped with a magnetic drum and magnetic roller ranging from 1,5000 to 21,000 G, although the rotary magnetic type or other types may be used.

The operational flow of the process covered by for the stages above is comprised of the following components:

1 First Stage:

### A—Drying

1.1—feeder silo for the input of materials or tailings (grain size smaller than 50 mm)
TC-01 belt conveyor leading to the dryer
2—rotary dryer with countercurrent drying
3—first exhaust system made up of:
3.1—cyclone battery
3.2—sleeve filter
TH-01—screw conveyor to take silica and ore from the cyclone to the silo 1,2 (for grain size smaller than 0.15 mm)
TH-02—screw conveyor to take clay from the sleeve filter to the silo 1,3 (grain size smaller than 0.15 mm)
1.2—silo for storage/output of silica and ore
1.3—silo for storage/output of clay

### B—Sieving

4—horizontal sieving unit equipped with a classifier having up to 5 (five) discharge chutes
TC-02—belt conveyor leading to the horizontal concentrator (grain size smaller than 1.0 mm)
TC-05—reversible belt conveyor leading to the TC-03 belt conveyor or to the horizontal concentrator (grain size smaller than 1.0 mm)
TC-06—belt conveyor that feeds the TC-08 belt conveyor (grain size larger than 1.0 mm and smaller than 6.3 mm)
TC-07—belt conveyors leading to magnetic separation (grain size smaller than 1.00 mm)
TC-08 belt conveyor leading to magnetic separation (grain size larger than 1.0 mm and smaller than 6.3 mm)
TC-09—belt conveyor to take ores for storage (grain size larger than 9.0 mm) in silo 1.4
   C—Horizontal concentration
5—horizontal concentrator
TC-03—belt conveyor to vertical air concentration (grain size smaller than 1.0 mm)
   D—Vertical air separation
6—vertical air concentrator
7—second clay exhaust system, made up of:

7.1—cyclone battery

7.2—sleeve-type filter
TH-03—screw conveyor to convey clay from the sleeve filter to the silo 1,5 (grain size smaller than 0.3 mm)

1.5—silo for storage/output of clay
TH-04—screw conveyor to take silica and ore from the cyclone to the TC-04 belt conveyor (for grain size smaller than 1.00 mm)
TC-04—belt conveyor to convey silica and ore to the magnetic separation unit

2 Second Stage:

E—Magnetic separation
8—Magnetic separator from 1,500 G to 21,000 G equipped with roller and drum
TCM-10 magnetic belt conveyor leading to the ore storage silo
TCM-11 magnetic belt conveyor leading to the ore storage silo
TC-12 belt conveyor leading to the silica storage silo
TCM-13 magnetic belt conveyor leading to the ore storage silo
TC-14 belt conveyor leading to the silica storage silo
1.6 to 1.10—silos for storage/output of silica and ore.

The loading of waste material with grain size of up to 50 mm and 12% moisture content comes first, with the material in the same conditions as it is when collected from the dams or tailings deposit (1.1); the material is poured into a feed silo for storage and input of material or tailings; it is then taken by a TC-01 belt conveyor to the countercurrent dryer (2), which is a horizontal rotary dryer equipped with fins to throw the particles of clay, silica and ore contained in the material or tailings. To improve the throwing and removal of the clay particles, the outlet of the dryer (2) will contain a burner fed by LPG gas with a countercurrent gas flow system. The material obtained after this drying process has a moisture content of 0 to 4%.

After the drying, the material is sent to the first exhaust system (3), with preset pressure and flow, in order to perform the first step of separation, passing afterwards through the cyclone battery (3.1) and sleeve-type filter (3.2), which will lead to the obtainment of clay, silica and ore in particles smaller than 0.15 mm; the silica and ore will be taken to the cyclone battery (3.1) while the clay and ore will be collected by the sleeve filter. (3.2). The particles of silica and ore smaller than 0.15 mm obtained in the exhaust process and unloaded from the cyclone battery (3.1) by rotating valves and the TH-01 screw conveyor, as well as the clay particles smaller than 0.15 mm collected during the exhaust process and unloaded into the sleeve filter (3.2) by the rotating valves and TH-02 screw conveyor will be stored in silos (1.2 and 1.3) for later use.

Particles of clay, silica and ore larger than 0.15 mm and not caught by the exhaust process will be directed by gravity to the feeder (4.1) for dry screening by a horizontal rotary or vibrating sieve (4) with controlled speed, pressure and flow; and by subsequent rotary screens (4.2) and (4.3) sequential grain size separators; the resulting will be classified, separated and directed to one of the five outlets of the sieving machine (4.4), determined by differentiated grain sized; more specifically:
smaller than 1.0 mm;
larger than 1.0 mm and smaller than 6.3 mm;
larger than 6.3 mm.

During sieving, the first exhaust system (3), with preset pressure and flow, will capture new material or tailings expelled by the sieving unit's exhaust fan (4.5) fan (4), which will then go through the cyclone battery (3.1) and sleeve filter (3.2); this will result in the obtainment, transportation and storage of clay, silica and ore (1.2 and 1.3) into the silos.

After the drying and the sifting, the material with grain size smaller than 1.0 mm subjected to a technical assessment to check the clay content; should it be a high clay concentration, it will be sent to the horizontal concentrator (5) by a TC-02 belt conveyor. Depending on the result obtained after sifting, material with grain size smaller than 1.0 mm may be sent to the horizontal concentrator by a TCR-05 reversing belt conveyor or be sent to the vertical air concentrator by a TC-03 belt conveyor.

Sieved material larger than 1.0 mm and smaller than 6.3 mm will be taken to the TC-06 or TC-08 belt conveyors for magnetic separation in order to be concentrated in magnetic drums and rollers contained in the separator (8). The material obtained from the sifting process that is larger than 6.3 and smaller than 9.0 mm is taken to a storage area (1.4) for processed material by a TC-09 belt conveyor.

The horizontal concentrator (5) will be supplied at the feeder (5.5) with material coming from the TC-02; it can also be fed with material of up to 1.0 mm, and it will perform the mechanical separation of clay, silica and ore particles contained in the material. The horizontal concentrator (5) is a rotary drum (5.1) equipped with inverters (not pictured here) to control frequency speed, internal pressure and gradient depending on the material to be concentrated, and providing mechanical friction by 15 fins (5.2) and stirring blades (5.3) in order to achieve suspension and stirring that will result in the release of clay stuck by ionization to the waste material and already dried in the horizontal dryer (2), as well as its gathering by the exhaust fan (5.4) in the first exhaust system comprised of a cyclone battery (3.1) and a sleeve-type filter (3.2).

During the horizontal concentration process the exhaust system (3), with preset pressure and flow, will collect new material or tailings that will then go through the cyclone battery (3.1) and sleeve filter (3.2); this will result in the obtainment, transportation and storage of clay, silica and ore.

All the material produced by horizontal concentration will be taken by the TC-03 belt conveyor to the vertical air concentrator (6) comprised of double or single rotor dry impact mills; hammer mills with sieves may also be used and/or ball mills or bar mills with their speed adjusted in accordance with the ore concentration in the material, and with exhaust control. Dry separation is achieved by using the speed of the rotors to generate centrifugal force to throw clay through the second exhaust system (7); the cyclones (7.1) and the sleeve filter (7.2). This vertical air concentrator will be fed all the material coming from the horizontal concentrator (5) that is of size up to 1.0 mm in order to extract the clay, silica and ore contained in the material or in the tailings.

After concentration (6), all the material will go through the second exhaust process (7), which will result in the obtainment of silica and ore in particles smaller than 1.0 mm that will be taken into the cyclone battery (7.1) while clay particles will be collected by the sleeve filter (7.2) and unloaded by rotating valves and a TH-03 screw conveyor into the silo for storage (1.5). The silica and ore particles caught in the exhaust process (7) will go through a cyclone battery (7.1) that is specific for different types of residues; they will be unloaded by rotating valves and a TH-04 screw conveyor and taken by a TC-04 belt conveyor to the magnetic separator (8). The function of the magnetic separator (8) is to separate the resulting silica and ore particles and formed a great many roller separators and a drum of 1,500 to 21,000 G, which will vary depending on the result achieved in the separation of clay in the previous stages.

The particles of silica and ore obtained after magnetic separation will be taken by five belt conveyors, two (TC-12 and TC-14) for the transportation of silica, and three magnetic belt conveyors (TCM-10, TCM-11 and TCM-13) for transportation of ore for storage in specific silos (1.6 to 1.10).

1-3. (canceled)

4. A method of extracting clay, silica and iron ore by dry concentration, comprising:
drying material in a dryer;
sifting the material in a horizontal rotary sieve including a plurality of chutes to corresponding to various grain sizes of the material;
removing clay from the material in a horizontal concentrator including a plurality of fins and stirring blades;
separating clay from the material by a centrifugal force in a vertical air concentrator; and
separating silica and iron ore from the material in a magnetic separator including magnetic drums and rollers of up to 21,000 G.

5. The method of claim 4, which includes linking the horizontal rotary sieve, the horizontal concentrator and the vertical air concentrator to an exhaust system.

6. The method of claim 4, which includes transporting material with a particle size of up to 50 mm and a moisture content of 12% on a conveyor belt to a horizontal rotary dryer.

7. The method of claim 6, wherein the horizontal rotary dryer includes fins to eject particles.

8. The method of claim 6, wherein the horizontal rotary dryer includes an LPG gas-fed flare with a countercurrent system designed to reduce the moisture content of the material to 0 to 4%.

9. The method of claim 6, which includes transporting the material through an exhaust system.

10. The method of claim 6, which includes trapping silica and iron ore particles smaller than 0.15 mm.

11. The method of claim 10, which includes unloading the silica and iron ore particles into a cyclone battery using rotating valves.

12. The method of claim 11, which includes transporting the silica and iron ore particles from a screw conveyor to a storage silo.

13. The method of claim 4, which includes sifting the material by particle size into the following groups: (1) particles smaller than about 1.0 mm; (ii) particles larger than about 1.0 mm and smaller than about 6.3 mm; and (iii) particles larger than about 6.3 mm.

14. The method of claim 4, which includes transporting material with a particle size greater than about 1.0 mm to the horizontal concentrator.

15. The method of claim 4, which includes transporting material with a particle size greater than about 1.0 mm to the magnetic separator.

16. The method of claim 4, wherein the vertical air concentrator includes double or single rotor dry impact mills, hammer mills with sieves and/or balls or bar mills.

17. The method of claim 4, which includes adjusting a speed of rotors in the vertical air concentrator to generate the centrifugal force and push the clay through the exhaust system.

18. The method of claim 4, wherein the horizontal concentrator includes invertors for controlling at least one of frequency speed, internal pressure and gradient for the material.

19. The method of claim 4, which includes stirring the clay in the horizontal separator to release clay stuck to the horizontal separator by ionization.
